(19) United States
(12) Patent Application Publication
(10) Pub. No.: US 2012/0240459 A1
(43) Pub. Date: Sep. 27, 2012

(54) TREE SUPPORT DEVICE

(76) Inventors: Stephen O'R. Curtis, Milford, DE (US); Nicholas O'R. Curtis, Milton, DE (US)

(21) Appl. No.: 13/423,753

(22) Filed: Mar. 19, 2012

Related U.S. Application Data
(60) Provisional application No. 61/466,666, filed on Mar. 23, 2011.

(51) Int. Cl. A01G 17/10; A01G 1/00

(52) U.S. Cl. 47/43; 47/58.1 R

(57) ABSTRACT

A re-usable tree stanchion designed to provide temporary safe support to a newly transplanted tree, while allowing it a full range of movement sufficient for the tree to develop a healthy and strong trunk base and root system. It prevents the tree from being uprooted or blown over in a strong wind until it can stand on its own without causing damage to the tree trunk. The support is supplied by a thin leg of supple material set in the ground adjacent to the newly planted tree. The leg curves over to meet the tree encircling it with a collar of soft, pliant material. These components together provide two stage shock absorption. When the tree moves with pressure from the wind it is first held softly by the collar which gives under pressure from the moving tree, then its movement is further decelerated by the spring action of the leg.

### CROSS-REFERENCE TO RELATED APPLICATION

This application claims priority to the U.S. Provisional Patent Application No. 61/466,666, filed on Mar. 23, 2011, which is incorporated herein in its entirety.

### FIELD OF INVENTION

This invention generally relates to a stand or a stanchion for supporting trees. Specifically, the present invention relates to support stand or a stanchion that provides support to trees such as a newly transplanted tree while allowing it a full range of movement. Such full range of movement can help the tree to develop a healthy and strong trunk base and root system. In addition, such support stand or stanchion can help prevent the tree from being uprooted or blown over in a strong wind until it can stand on its own without causing damage to the tree trunk.

### BACKGROUND

Existing methods of supporting transplanted trees do not allow the tree a full range of movement. They are mostly rigid and hold the tree tight, which often leads to either severe damage to the tree or, at best, does not permit the tree to grow under optimum conditions so that it can develop naturally and thrive on its own. The typical wire-and-stake method often causes damage to bark, shortening the life of the tree, or worse, girdling the tree, thereby killing it. Other support systems may allow limited movement under force of wind, but then stop its movement abruptly that can lead to bark damage or even fracturing and breakage with high wind gusts.

Improperly supported transplanted trees can develop reverse trunk taper and slow root spread, making them dependent on artificial support for survival. Such trees can also experience accelerated growth that leads to an imbalance between the tree canopy and root stock and uneven xylem growth, if a stake is driven too close to the trunk. Therefore, a more holistic and tree-centric support system is needed.

### SUMMARY OF INVENTION

This invention provides trees such as transplanted trees freedom to move in the wind up to a point, in order to develop a strong trunk base and root system that helps them resist wind damage on their own. It is also a recognized fact that the tree's bark and life sustaining cambium is particularly susceptible to damage when young. This invention addresses both of these issues directly allowing the tree to develop more naturally while protecting it from being uprooted by high winds until its roots have taken hold. The device is also suited for remedial support of established trees whose root systems have been compromised or for temporary support of trees in nurseries, either in ground, boxed, with balled and burlapped roots, or in containers.

This invention provides all the best support for a tree using the most streamlined and efficient form. It is safer for pedestrians, reducing the tripping and other hazards that exist with guy wires and stakes that are hard to see. In one embodiment, it is made of recyclable materials and is reusable. In addition, it is inexpensive to manufacture, and is easy to install. Its single line form is sculptural in its simplicity and can be painted with bright colors to increase visibility and to make a design statement.

In one embodiment, this invention relates to a tree support stand, comprising:
(A) a curved bar leg, wherein said bar leg comprises of:
   (i) a nominally straight portion at a first end, wherein said first end of said curved bar leg is inserted into the ground adjacent to a tree,
   (ii) a nominally straight portion at the second end, wherein said second end of said curved bar leg is made proximate to said tree, and
   (iii) a curved portion of said curved bar leg that is a continuation of said first end and said second end;
(B) at least one hose-holder, comprising a first end and a second end, wherein said hose-holder is connected to said curved bar leg at said second end of said curved bar leg by at least one connection means, wherein said at least one hose-holder is connected to said second end of said curved bar leg at said at least one hose-holder's nominal center, wherein said at least one hose-holder is nominally perpendicular in direction to said longer portion of said curved bar leg; and
(C) a hose connected to at least first end of said at least one hose-holder.

This invention also relates to a process for providing support to a tree, comprising:
(A) planting a tree in a base;
(B) inserting in said base or ground, a tree support stand as recited in the embodiment above, adjacent said tree of step A;
(C) extending said hose connected to said first end of said at least one hose-holder such that said hose encircles said tree; and
(D) connecting said hose at its other end to said second end of said at least one hose-holder.

### BRIEF DESCRIPTION OF DRAWINGS

FIG. 1 shows the side view of the tree support device.

FIG. 2 shows the back view of the tree support device.

FIG. 3 shows the top view of the tree support device.

FIG. 4 is a schematic of a tree being supported by the tree support device of the present invention.

FIG. 5a shows the elevation and FIG. 5b shows the top view of an alternative embodiment of the tree support device with one collar that is supported by two bar legs.

FIG. 6a shows the side view; FIG. 6b shows the back view and FIG. 6c shows the top view of an alternative embodiment of the tree support device with two collars that are supported by one bar leg.

### DETAILED DESCRIPTION OF THE INVENTION

It is not intended that the invention be limited to the specific terms, each specific term including all technical equivalents which operate in a similar manner to accomplish a similar purpose.

In this patent application, ranges are used as shorthand only to avoid listing and describing each and every value within the range. Any appropriate value within the range can be selected as the upper value, the lower value, or the end-point of the range.

In this patent application, the singular form of a word includes its plural, and vice versa, unless the context clearly dictates otherwise. Thus, references “a,” “an,” and “the” generally include the plurals of the respective terms they qualify. For example, reference to “a method” includes its plural—“methods.” Similarly, the terms “comprise,” “comprises,” and “comprising,” whether used as a transitional phrase in the claims or otherwise, should be interpreted inclusively rather than exclusively. Likewise the terms “include,” “including,” and “or” should be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods, compositions, and other advances disclosed in this patent application are not limited to particular methodology, protocols, and reagents described in the application because, as the skilled artisan will appreciate, they may vary. Further, the terminology used in this application describes particular embodiments only, and should not be construed as limiting the scope of what is disclosed or claimed.

Unless defined otherwise, all technical and scientific terms, terms of art, and acronyms used in the present application have the meanings commonly understood by one of ordinary skill in the art in the field(s) of the invention, or in the field(s) where the term is used. Although any compositions, methods, articles of manufacture, or other means or materials similar or equivalent to those described in the present patent application can be used in the practice of the present invention, specific compositions, methods, articles of manufacture, or other means or materials are described only for exemplification.

All patents, patent applications, publications, technical and/or scholarly articles, and other references cited or referred to in this patent application are incorporated in their entirety by reference to the extent allowed by law. The discussion of those references is intended merely to summarize the assertions made in these references. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

By “tree” is mean any plant, sapling, creeper, or a tree of any size.

In one embodiment, this invention provides a re-usable tree stanchion designed to provide temporary safe support to a tree, such as a newly transplanted tree, while allowing it a full range of movement. The full range of movement may help the tree to develop a healthy and strong trunk base and root system. It may help prevent the tree from being uprooted or blown over in a strong wind until it can stand on its own without causing damage to the tree trunk. In one embodiment, the support is supplied by a thin leg of supple material set in the ground adjacent to the newly planted tree. The leg curves over to meet the tree encircling it with a collar of soft, pliant material. These components together provide a two-stage shock absorption. When the tree moves with pressure from the wind it is first held softly by the collar which gives under pressure from the moving tree, then its movement is further decelerated by the spring action of the leg.

The device of the present invention can be made from various materials. The collar or the hose must be yielding enough in high wind to cushion the tree trunk without damage to the bark, yet strong enough to resist pressure from the tree. In one embodiment, the leg must also have enough spring to further absorb the movement of the tree once it has reached the full extension of the collar. In one embodiment, the whole support must all the while provide sufficient resistance to prevent the tree from being uprooted by high winds.

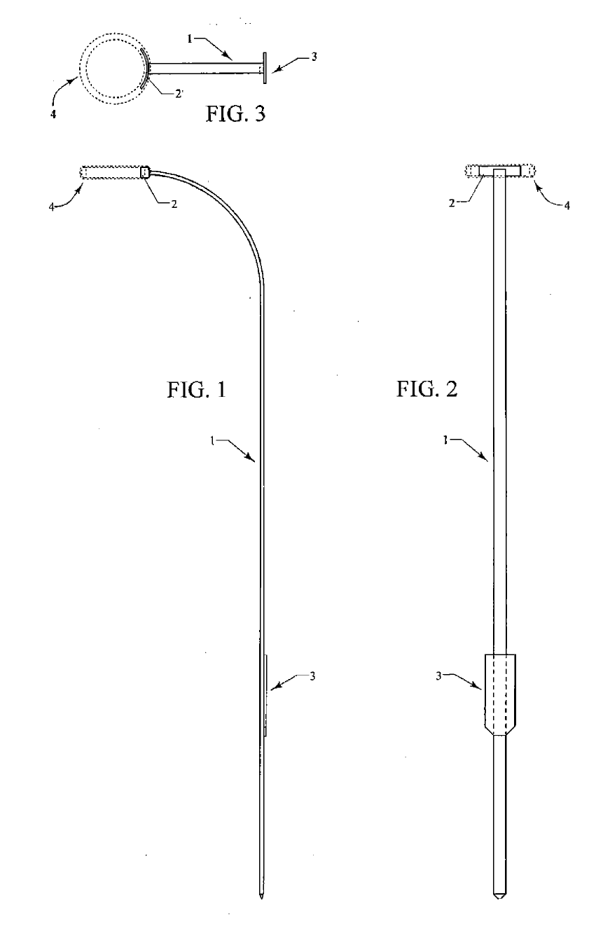

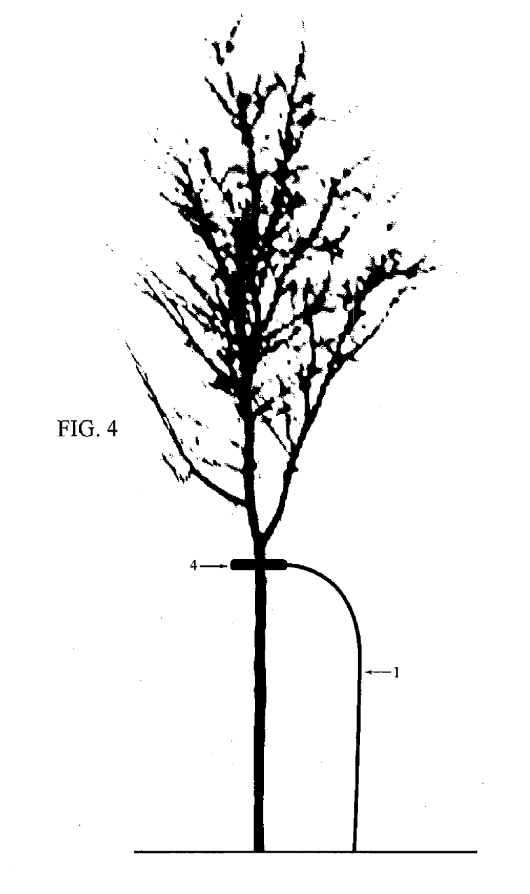

Referring to the drawing in FIG. 1, a preferred embodiment is comprised of a steel flat bar legs, which curves over to meet the tree with a hose-holder 2 welded generally at right angles to the leg designed to hold a soft, flexible hose 4, (shown with dotted line). In other embodiments, the steel bar leg 1 need not be flat and could be simply cylindrical, for example. Similarly, the hose-holder 2 need not be flat and/or need not meet the bar leg at a right angle.

In one embodiment, the flexible hose 4 is a fiber-reinforced plastic hose that has an inside diameter smaller than the width of the hose-holder 2 so that the hose is forced into an ovalized shape. This distortion of the hose matches the natural ovalizing that occurs in the hose section when it is bent in a tight radius. This ovalizing provides a flat, round edged surface, which is ideal for cushioning the tree without damage to its bark. In another embodiment, the flexible hose 4 is not made of plastic or a fiber-reinforced plastic, but any other soft material. In yet another embodiment, the diameter of the plastic hose is not smaller than the diameter of the hose-holder, but in fact the same size or slightly bigger diameter.

The hose-holder is connected to the curved bar leg by any one of the several available connection means. Connection means envisioned by the present invention includes welding, gluing, taping, single-cast formation, etc. of the hose-holder to the curved bar leg. Generally, the curved bar leg and the hose-holder are made of the same material. A preferred material both for the curved bar leg and the hose-holder is metal. Another preferred material is plastic. Another preferred material is reinforced plastic. A combination of curved bar leg made from one material and the hose-holder made from another material is envisioned within the scope of the present invention.

In one embodiment, a tie means such as a flat plastic adjustable “zip” tie is passed through the center of the hose and tightened up where the hose ends come together at the top of the leg, (not shown in drawing). This ensures that the flexible hose 4 will not be pulled off its hose-holder 2. A locking steel cable can be used instead as a deterrent to theft.

In yet another embodiment of the present invention, a flat bar, spade-shaped part 3 is welded to the leg 1 to provide greater resistance to wind pressure when the spade is at or below grade, and prevent the leg loosening in the ground. It also reduces pivoting of the leg under lateral pressure. In addition, this spade part 3 provides a “shoulder” or horizontal surface that can be used to drive the support into the ground. It can be driven either directly with a hammer or with the use of a simple intermediate tool made of a short length of steel channel that catches the shoulders of the spade-like part 3 on both sides of the leg simultaneously. Alternatively, using his leg, the user can push the stanchion into the ground by repeated or continuously pushing the flat bar, spade-shaped part 3 into the ground.

Because generally the wind direction in a region tends to remain consistent, in one embodiment, the tree support may be installed on the side of the tree of the prevailing wind, with its arched “back” into the wind. This is so it can best cushion the movement of the tree, while still allowing it sufficient movement to favor growth of a strong trunk base and root system.

The collar or hose 4 is normally installed around the trunk just below the lowest branches. The support can be driven to different depths to accommodate different heights of branches. This invention can be made in a variety of sections or weights of materials, or other materials designed to best accommodate various sizes of trees and soil conditions. The flexibility of the materials must be in proportion to the needs of a given tree. Two basic sizes however can accommodate the typical range of sizes of trees normally chosen for transplant. If it is determined that more support is needed for a given tree because of especially high winds, a second leg can easily be incorporated within the same collar, or installed with its own collar to double up on support for the tree, while still allowing movement. Separate supports can be installed at different heights and different angles to spread support along the tree trunk in order to avoid single point wind shear and cope with varying wind force and direction. The invention in its basic form and function can either be driven into ground as described or adapted for mounting to hard surfaces, such as a tree grate, with the use of a flange or bracket.

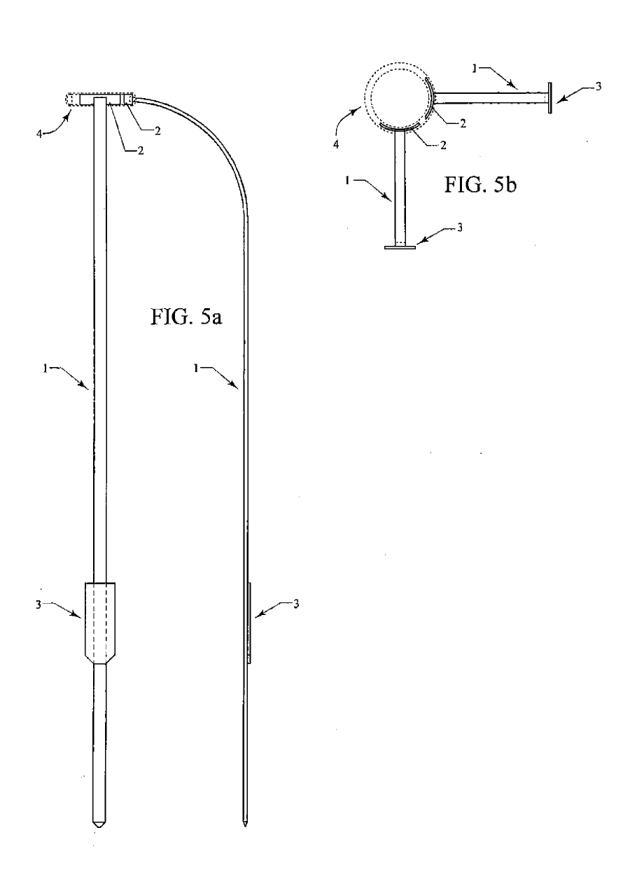

In one embodiment, the present invention relates to a tree support device that has two curved bar legs that are attached to one hose, with two hose-holders (See FIG. 5). In a preferred embodiment, the curved bar legs are set-off from each other at 90°, but other angles between 0° and 180° are also envisioned within this invention, for example, 45°, 135°, 180° and the intermediate angles. In a preferred embodiment, two separate tree supports with hose holders can be coupled using the same hose—in two parts with a single tie running in the center of the two section hose.

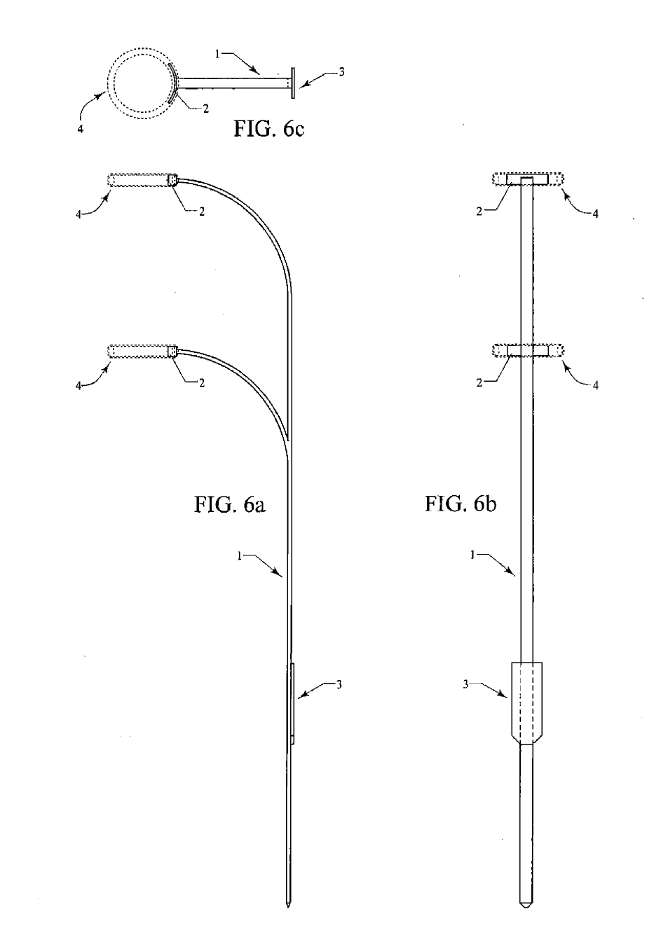

In yet another embodiment, the present invention relates to a curved bar leg comprising two or more hoses and hose-holders (See FIG. 6).

In another embodiment, the present invention relates to two or more separate tree support stanchions with the hose-holder and corresponding hose adjusted to different heights and set at same or different angles to provide extra support and resistance to wind shear.

This invention can also be used for shrubs or plants that may be in pots. In such case, the tree support system will be anchored to a base on which the pot is placed.

The primary focus of this invention is to provide newly transplanted trees the ability to move enough to build a strong trunk base and root system. The invention accomplishes this by absorbing the force of damaging winds without harm to a tree's most sensitive and life sustaining elements: the protective bark and cambium layers housing the food conducting cells of the tree and its root system. It is this gradual deceleration of a tree's momentum that distinguishes this invention from others that claim to allow movement, but stop movement abruptly risking damage to the tree.

The key elements of an embodiment of the present invention are:
1. The use of a collar made of soft, pliable material fitted around the tree trunk and suspended at an appropriate height to prevent the tree from being up rooted or bending excessively. This collar is loose enough to allow the bark to breath freely and not constrict the flow of life-sustaining fluids. It is also soft and supple enough to absorb contact from the tree without cutting into or abrading the bark.
2. A leg of spring-like material which holds the collar and will bend to gently slow the inertia of the tree once it has reached the full extension of the soft collar. The leg provides just enough resistance to the tree's movement to prevent disruption of root growth.
3. A spade-like part attached to the leg to limit in-ground movement of the device, including rotation.
4. The same spade-like part also providing a shoulder to use for driving the device into the ground.
5. The means to vary the height of the whole device by adjusting the length of the leg above grade.
6. The ability to scale the device to match the size of the transplanted tree and other plants and their planting conditions.

Together, these elements provide a very effective two stage shock absorption that cushions a tree, allowing it a sufficient range of movement for healthy growth while preventing typical wind damage.

This is a simple straightforward device that relies on the right choice of materials to provide an elegant, cost effective and re-usable solution to a long standing challenge. This challenge is the protection of a considerable investment in a transplanted tree in order to insure a return of many years of healthy life and service to our environment in the form of beauty, animal habitat, shade and air purification.

1. A tree support stand, comprising:
(A) at least one curved bar leg, wherein said bar leg comprises of:
(i) a nominally straight portion at a first end, wherein said first end of said curved bar leg is inserted into the ground adjacent to a tree,
(ii) a nominally straight portion at the second end, wherein said second end of said curved bar leg is made proximate to said tree, and
(iii) a curved portion of said curved bar leg that is a continuation of said first end and said second end;
(B) at least one hose-holder comprising a first end and a second end, wherein said hose-holder connected to said curved bar leg at said second end of said curved bar leg by at least one connection means, wherein said at least one hose-holder is connected to said second end of said curved bar leg at said at least one hose-holder's nominal center, wherein said at least one hose-holder is nominally perpendicular in direction to said longer portion of said curved bar leg; and
(C) a hose connected to at least first end of said at least one hose-holder.

2. The tree support stand as recited in claim 1, wherein said hose is made from a flexible plastic material, flexible, reinforced plastic material, or rubber.

3. The tree support stand as recited in claim 1, wherein on said nominally straight portion of said first end of said curved bar leg further comprises a flat bar, spade shaped part connected to said first end of said curved bar leg.

4. The tree support stand as recited in claim 1, wherein a tie means is passed through said at least one hose, from its first end to its second end and tightened up where said at least one hose's said first end and said second end come together at the top of said curved bar leg.

5. The tree support stand as recited in claim 1, wherein at least two hoses are attached to said curved bar leg at two different heights.

6. The tree support stand as recited in claim 1, wherein said inside edge of said hose is oval-shaped in cross-section conforming to the general shape of said hose-holder.

7. The tree support stand as recited in claim 1, wherein one hose is connected to two curved bar legs.

8. The tree support stand as recited in claim 7, wherein the angle between said two curved bar legs is within the range of from about 0° to about 180°.

9. A process for providing support to a tree, comprising:
(A) planting a tree in a base;
(B) inserting in said base or ground, a tree support stand as recited in claim 1, adjacent said tree of step A;
(C) extending said hose connected to said first end of said at least one hose-holder such that said hose encircles said tree; and
(D) connecting said hose at its other end to said second end of said at least one hose-holder.

10. A process for providing support to a tree, comprising:
(A) planting a tree in a base;
(B) inserting in said base or ground, a tree support stand as recited in claim 3, adjacent said tree of step A;
(C) extending said hose connected to said first end of said at least one hose-holder such that said hose encircles said tree; and
(D) connecting said hose at its other end to said second end of said at least one hose-holder.
